(19) United States
(12) Patent Application Publication
(10) Pub. No.: US 2015/0264318 A1
(43) Pub. Date: Sep. 17, 2015

(54) Method for Getting a Device Online, Address Delivery Method, Peripheral Unit, Server, and Monitoring System

(71) Applicant: ZTE CORPORATION, Shenzhen, Guangdong (CN)

(72) Inventors: Kedi Ma, Shenzhen (CN); Yonghong Zhou, Shenzhen (CN); Donghui Wang, Shenzhen (CN)

(21) Appl. No.: 14/436,632

(22) PCT Filed: Aug. 28, 2013
(86) PCT No.: PCT/CN2013/082428

§ 371 Date: Apr. 17, 2015

(30) Foreign Application Priority Data
Oct. 19, 2012 (CN) 201210400660.X

(51) Int. Cl. H04N 7/18

(52) U.S. Cl. CPC H04N 7/18

(57) ABSTRACT

A method for getting a device online, a method for sending addresses, a front-end device, a server and a surveillance system are provided, wherein the method for getting a device online includes: a front-end device carrying its own device identification to request a central management server for a registration; receiving a device address assigned by the central management server to the front-end device after the registration is successful; using the device address to request an online management server for getting online, receiving a request response fed back by the online management server. Through the above technical solution, the embodiment of the present invention solves the problem that the front-end devices need to be manually configured with device IDs one by one.

### TECHNICAL FIELD

The present document relates to the field of video surveillance, and more particularly, to a method for getting a video surveillance front-end device online, a method for sending device addresses, a front-end device, a central management server and a video surveillance system.

### BACKGROUND OF THE RELATED ART

The applications of video surveillance service are wider and wider, and currently, after video surveillance front-end devices are installed, the front-end devices need to be manually configured with device IDs one by one, so that the devices can be connected to the video surveillance system.

The traditional method for getting a video surveillance front-end device online comprises the following process: a video surveillance system assigns one device ID to each front-end device, and after the front-end devices are installed, the front-end devices need to be manually configured with their corresponding device IDs, and after the front-end devices are connected to the network, they carry their device IDs to register to a central management server, and after the registration is successful, the front-end devices carry their device IDs to submit applications for getting online to an online management server, and after getting online successfully, the front-end devices can normally access the video surveillance system to carry out various video surveillance services.

A medium-sized video surveillance system has at least thousands of front-end devices, and since the front-end devices need to be manually configured with device IDs one by one, the labor costs are increased, and meanwhile it also results in the getting-online period of the front-end devices being lengthened.

### SUMMARY OF THE INVENTION

The present document provides a method for getting a device online, an address delivery method, a front-end device, a server and a surveillance system, to solve the problem in the related art that front-end devices need to be manually configured with device address (ID) one by one.

To solve the abovementioned technical problem, the present document takes the following technical solutions.

A method for getting a video surveillance front-end device online comprises: a front-end device carrying its own device identification to request a central management server for a registration; after the registration is successful, receiving a device address assigned by the central management server to the front-end device; using the device address to request an online management server for getting online, and receiving a request response fed back by the online management server.

Preferably, the device's own device identification is a medium access control address.

Preferably, after the registration is successful, the front-end device further receives an address of the online management server sent by the central management server, and the front-end device establishes a connection to the online management server according to the address of the online management server.

A method for sending a device address of video surveillance front-end device comprises: a central management server receiving a registration request from a front-end device, wherein the registration request carries the front-end device's own device identification; after completing the registration request of the front-end device, the central management server assigning a device address to the front-end device; the central management server delivering the device address to the front-end device, correlating the device address with the front-end device's own device identification and performing saving.

Preferably, the device's own device identification is a medium access control address.

A front-end device comprises a registration requesting module, a device address receiving module and a getting online module, wherein:
the registration requesting module is configured to: carry the front-end device's own device identification to request a central management server for a registration;
the device address receiving module is configured to: after the registration is successful, receive a device address assigned by the central management server to the front-end device;
the getting online module is configured to: use the device address to request an online management server for getting online; receive a request response fed back by the online management server.

Preferably, the device address receiving module is further configured to: after the registration is successful, receive an address of the online management server sent by the central management server.

A central management server comprises a registration module, an address assignment module, an address sending module and an address correlation module, wherein:
the registration module is configured to: receive a registration request from a front-end device and complete a registration, wherein the registration request carries the front-end device's own device identification;
the address assignment module is configured to: assign a device address to the front-end device;
the address sending module is configured to: send the device address to the front-end device;
the address correlation module is configured to: correlate the device address with the front-end device's own device identification and perform saving.

Preferably, the address sending module is further configured to: send the address of the online management server.

A video surveillance system, characterized in that, it comprises the abovementioned front-end device, the abovementioned central management server and the online management server, wherein:
the front-end device is configured to: carry its own device identification to request the central management server for a registration; after the registration is successful, receive a device address assigned by the central management server to the front-end device; use the device address to request the online management server for getting online; receive a request response fed back by the online management server;
the central management server is configured to: receive a registration request from the front-end device and complete a registration, wherein the registration request carries the front-end device's own device identification; assign a device address to the front-end device; send the device address to the front-end device, correlate the device address with the front-end device's own device identification and perform saving;
the online management server is configured to: receive a getting-online request from the front-end device, judge whether the front-end device is allowed to get online or not according to the device address in the getting-online request, and feed back a request response to the front-end device.

The beneficial effects of the embodiments of the present invention are: achieving a registration to the central management server with the front-end device's own device identification, and after the registration is successful, receiving a device ID assigned by the central management server, thus automatically configuring the device ID, and after the configuration of device ID is completed, the device ID can be used to request to get online without human participation, thus shortening the getting-online period of the front-end device and saving the labor costs.

### BRIEF DESCRIPTION OF THE DRAWINGS

FIG. 1 is a flow chart of a method for getting a video surveillance front-end device online provided in an embodiment of the present invention;

FIG. 2 is a schematic diagram of a video surveillance system provided in an embodiment of the present invention.

### PREFERRED EMBODIMENTS OF THE INVENTION

The main idea of the embodiments of the present invention is: using the video surveillance front-end device's own device identification to achieve a registration to the central management server, and after the registration is successful, receiving a device ID assigned by the central management server to automatically complete the configuration of the device ID without human participation. After completing the configuration of the device address, the device address can be used to request to get online. The front-end device's own device identification refers to information playing the role of identification, including but not limited to the identification information preset in the front-end device when leaving the factory, and the identification information generated by the front-end device itself, such as the media access control (MAC) address. Such kind of identification information can avoid the additional step of setting identification information during the using process. The device ID assigned by the central management server is mainly used in the video surveillance system and works as the front-end device's unique identification in the video surveillance system.

The front-end device can be any device with video capture function, such as a network camera, a network encoder, a mobile phone, a PDA and so on.

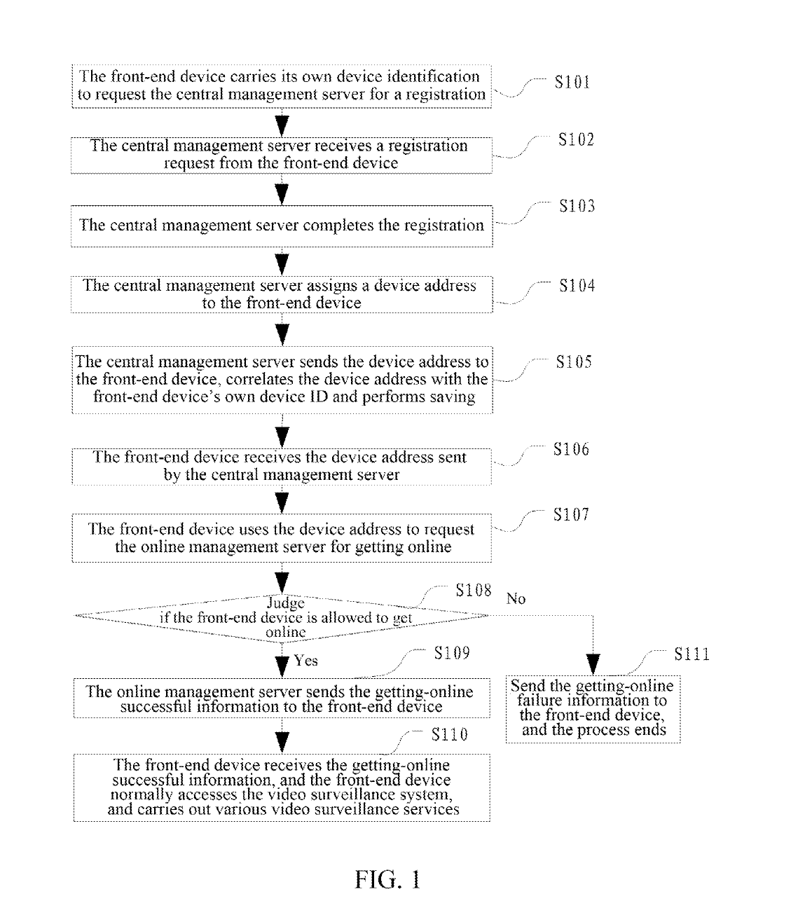

FIG. 1 is a flow chart of a method for getting a video surveillance front-end device online provided in an embodiment of the present invention, and as shown in FIG. 1, it comprises the following steps:
in S101, the front-end device carries its own device identification to request the central management server for a registration. Specifically, the front-end device sends a registration request carrying its own device identification to the central management server.

Typically, the address of the central management server at each project office point is known and unique, therefore the address of the central management server can be preset in the front-end device, which facilitates the front-end device to establish a connection to the central management server. The communication mode between the front-end device and the central management server can be a wired or wireless connection.

In S102, the central management server receives a registration request from the front-end device.

In S103, the central management server completes the registration.

In S104, the central management server assigns a device ID to the front-end device, and the device ID is unique for the front-end device in the same video surveillance system and mainly used for getting the front-end device online.

In S105, the central management server sends the device ID to the front-end device, correlates the device ID with the front-end device's own device identification, and performs saving.

Meanwhile, the central management server can also send the address of the online management server to the front-end device. Thus the front-end device would not need to save the address of the online management server by default or obtain the address of the online management server from other devices.

Preferably, the central management server can correlate the device ID with the front-end device's own device identification and save it in a correlation list.

In S106, the front-end device receives the device ID sent by the central management server.

In S107, the front-end device uses the device ID to request the online management server for getting online.

Specifically, the front-end device establishes a connection to the online management server according to the address of the online management server. The address of the online management server can be saved by the front-end device by default, or sent by the central management server in step S105, or obtained by the front-end device from other devices.

The communication mode between the front-end device and the online management server may be a wired or wireless connection.

In S108, the online management server receives a getting-online request from the front-end device, and judges whether the front-end device is allowed to get online or not according to the device ID in the getting-online request, if yes, proceeding to step S109, otherwise proceeding to step S111.

The specific process of the online management server judging whether the front-end device is allowed to get online according to the device ID in the getting-online request can be: the online management server inquiring the device ID list, and judging whether the device ID in the getting-online request exists in the device ID list or not, and if yes, allowing the front-end device to get online, otherwise, not allowing the front-end device to get online. The device ID list is provided by the central management server, and the device ID list can be the same as or different from the correlation list saved in the central management server.

The communication mode between the central management server and the online management server may be a wired or wireless connection.

In S109, the online management server sends the getting-online successful information to the front-end device.

In S110, the front-end device receives the getting-online successful information, and the front-end device normally accesses the video surveillance system and thus carries out various video surveillance services.

In S111, if the front-end device is not allowed to get online, it is to send the getting-online failure information to the front-end device, and the process ends.

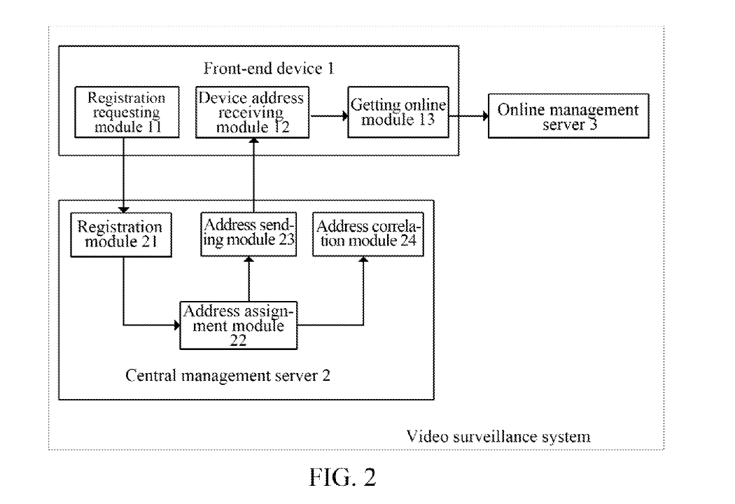

FIG. 2 is a schematic diagram of a video surveillance system provided in an embodiment of the present invention, and as shown in FIG. 2, the video surveillance system comprises at least one front-end device 1, a central management server 2 and an online management server 3, wherein the communication mode between the front-end device 1 and the central management server 2 as well as the online management server 3 may be a wired or wireless connection. The communication mode between the central management server 2 and the online management server 3 may be a wired or wireless connection. The front-end device 1 is used to carry its own device identification to request the central management server 2 for a registration; after the registration is successful, receive the device ID assigned by the central management server 2 to the front-end device 1; use the device ID to request the online management server 3 for getting online; receive a request response fed back by the online management server 3. The central management server 2 is used to receive a registration request from the front-end device 1 and complete the registration, wherein the registration request carries the front-end device's own device identification; assign a device ID to the front-end device 1; send the device ID to the front-end device 1, correlate the device ID with the front-end device's own device identification and save it. The online management server 3 is used to receive a getting-online request from the front-end device 1, and judge whether the front-end device is allowed to get online or not according to the device ID in the getting-online request, and feed back a request response to the front-end device 1.

Specifically, the front-end device 1 can send a registration request carrying its own device identification to the central management server 2. Its own device identification can be any information playing the role of identification. Preferably, its own device identification can be a medium access control (MAC) address. After completing the registration of the front-end device 1, the central management server 2 assigns a device ID to the front-end device 1. The central management server 2 may also send the address of the online management server 3 to the front-end device 1. Thus the front-end device 1 does not need to save the address of the online management server 3 by default or obtain it from other devices. The front-end device 1 establishes a connection to the online management server 3 according to the address of the online management server 3, and the getting-online request carries the device ID of the front-end device 1. The online management server 3 judges whether the front-end device 1 is allowed to get online or not according to the device ID in the getting-online request, and if yes, the online management server 3 sends the getting-online successful information to the front-end device 1, and the front-end device 1 receives the getting-online successful message, and the front-end device 1 normally accesses the video surveillance system, so as to carry out various video surveillance services. If no, the getting-online failure information is sent to the front-end device 1, and the process ends.

The front-end device 1 may further comprise a registration requesting module 11, a device address receiving module 12 and a getting online module 13, wherein:
the registration requesting module 11 is used to carry the front-end device l′s own device identification to request the central management server 2 for a registration. Specifically, the registration requesting module 11 may send a registration request carrying its own device identification to the central management server 2. Its own device identification can be any information playing the role of identification. Preferably, its own device identification may be a medium access control (MAC) address.

The device address receiving module 12 is used to: after the registration is successful, receive a device ID assigned by the central management server 2 to the front-end device 1. Preferably, the device address receiving module 12 may also be used to: after the registration is successful, receive an address of the online management server sent by the central management server.

The getting online module 13 is used to use the device ID to request the online management server 3 for getting online, and receive a request response fed back by the online management server 3.

The central management server 2 may further comprise a registration module 21, an address assignment module 22, an address sending module 23 and an address correlation module 24, wherein:
the registration module 21 is used to receive a registration request from the front-end device 1 and completes the registration, wherein the registration request carries the front-end device 1's own device identification.

The address assignment module 22 is used to assign a device ID to the front-end device 1.
the address sending module 23 is used to send the device ID to the front-end device 1; preferably, the address sending module 23 is further used to send the address of the online management server 3.

The address correlation module 24 is used to correlate the device ID with the front-end device 1's device address sending module and save it.

The above content is a further and detailed description of the present document with reference to the specific embodiments, and cannot be identified that the specific embodiments of the present invention are only limited to the description. For a person ordinarily skilled in the art of the present document, on the premise of without departing from the concept of present document, a number of simple deductions or replacements can also be made, and these deductions and replacements should be considered as belonging to the protection scope of the present document.

### INDUSTRIAL APPLICABILITY

The embodiments of the present invention use the front-end device's own device identification to achieve the registration to the central management server, and receive a device ID assigned by the central management server after the registration is successful, thus automatically configuring the device ID, and after the configuration of device ID is completed, the device ID can be used to request to get online without human participation, thus shortening the getting-online period of the front-end device and saving the labor costs.

What is claimed is:

1. A method for getting a video surveillance front-end device online, comprising:
a front-end device carrying device identification of the front-end device to request a central management server for a registration;
after the registration is successful, receiving a device address assigned by the central management server to the front-end device;
using the device address to request an online management server for being online, and receiving a request response fed back by the online management server.

2. The method for getting a video surveillance front-end device online of claim 1, wherein the device identification of the front-end device is a medium access control address.

3. The method for getting a video surveillance front-end device online of claim 1, wherein after the registration is successful, the front-end device further receives an address of the online management server sent by the central management server, and the front-end device establishes a connection to the online management server according to the address of the online management server.

4. A method for sending a device address of video surveillance front-end device, comprising:
a central management server receiving a registration request from a front-end device, wherein the registration request carries device identification of the front-end device;
after completing a registration of the front-end device, the central management server assigning a device address to the front-end device;
the central management server sending the device address to the front-end device, correlating the device address with the device identification of the front-end device and performing saving.

5. The method for sending a device address of video surveillance front-end device of claim 4, wherein the device identification of the front-end device is a medium access control address.

6. A front-end device, comprising a registration requesting module, a device address receiving module and a getting online module, wherein:
the registration requesting module is configured to: carry device identification of the front-end device to request a central management server for a registration;
the device address receiving module is configured to: after the registration is successful, receive a device address assigned by the central management server to the front-end device;
the getting online module is configured to: use the device address to request an online management server for being online; receive a request response fed back by the online management server.

7. The front-end device of claim 6, wherein the device address receiving module is further configured to: after the registration is successful, receive an address of the online management server sent by the central management server.

8. A central management server, comprising a registration module, an address assignment module, an address sending module and an address correlation module, wherein:
the registration module is configured to: receive a registration request from a front-end device and complete a registration, wherein the registration request carries device identification of the front-end device;
the address assignment module is configured to: assign a device address to the front-end device;
the address sending module is configured to: send the device address to the front-end device;
the address correlation module is configured to: correlate the device address with the device identification of the front-end device and performs saving.

9. The central management server of claim 8, wherein the address sending module is further configured to: send an address of the online management server.

10. A video surveillance system, comprising a front-end device, the central management server of claim 8, and an online management server, wherein:
the front-end device comprises a registration requesting module, a device address receiving module and a getting online module, wherein:
the registration requesting module is configured to: carry the device identification of the front-end device to request a central management server for a registration;
the device address receiving module is configured to: after the registration is successful, receive a device address assigned by the central management server to the front-end device;
the getting online module is configured to: use the device address to request an online management server for being online; receive a request response fed back by the online management server;
the front-end device is configured to: carry the device identification of the front-end device to request the central management server for a registration; after the registration is successful, receive a device address assigned by the central management server to the front-end device; use the device address to request the online management server for being online; receive a request response fed back by the online management server;
the central management server is configured to: receive a registration request from the front-end device and complete a registration, wherein the registration request carries the device identification of the front-end device; assign a device address to the front-end device; send the device address to the front-end device, correlate the device address with the device identification of the front-end device and perform saving;
the online management server is configured to: receive a getting-online request from the front-end device, judge whether the front-end device is allowed to be online or not according to a device address in the getting-online request, and feed back a request response to the front-end device.

11. The method for getting a video surveillance front-end device online of claim 2, wherein after the registration is successful, the front-end device further receives an address of the online management server sent by the central management server, and the front-end device establishes a connection to the online management server according to the address of the online management server.

12. A video surveillance system, comprising a front-end device, the central management server of claim 9, and an online management server, wherein:
the front-end device comprises a registration requesting module, a device address receiving module and a getting online module, wherein:
the registration requesting module is configured to: carry the device identification of the front-end device to request a central management server for a registration;
the device address receiving module is configured to: after the registration is successful, receive a device address assigned by the central management server to the front-end device;
the getting online module is configured to: use the device address to request an online management server for being online; receive a request response fed back by the online management server;
the front-end device is configured to: carry the device identification of the front-end device to request the central management server for a registration; after the registration is successful, receive a device address assigned by the central management server to the front-end device; use the device address to request the online management server for being online; receive a request response fed back by the online management server;
the central management server is configured to: receive a registration request from the front-end device and complete a registration, wherein the registration request carries the device identification of the front-end device; assign a device address to the front-end device; send the device address to the front-end device, correlate the device address with the device identification of the front-end device and perform saving;
the online management server is configured to: receive a getting-online request from the front-end device, judge whether the front-end device is allowed to be online or not according to a device address in the getting-online request, and feed back a request response to the front-end device.

13. A video surveillance system, comprising a front-end device, the central management server of claim 8, and an online management server, wherein:
the front-end device comprises a registration requesting module, a device address receiving module and a getting online module, wherein:
the registration requesting module is configured to: carry the device identification of the front-end device to request a central management server for a registration;
the device address receiving module is configured to: after the registration is successful, receive a device address assigned by the central management server to the front-end device; after the registration is successful, receive an address of the online management server sent by the central management server;
the getting online module is configured to: use the device address to request an online management server for being online; receive a request response fed back by the online management server;
the front-end device is configured to: carry the device identification of the front-end device to request the central management server for a registration; after the registration is successful, receive a device address assigned by the central management server to the front-end device; use the device address to request the online management server for being online; receive a request response fed back by the online management server;
the central management server is configured to: receive a registration request from the front-end device and complete a registration, wherein the registration request carries the device identification of the front-end device; assign a device address to the front-end device; send the device address to the front-end device, correlate the device address with the device identification of the front-end device and perform saving;
the online management server is configured to: receive a getting-online request from the front-end device, judge whether the front-end device is allowed to be online or not according to a device address in the getting-online request, and feed back a request response to the front-end device.

14. A video surveillance system, comprising a front-end device, the central management server of claim 9, and an online management server, wherein:
the front-end device comprises a registration requesting module, a device address receiving module and a getting online module, wherein:
the registration requesting module is configured to: carry the device identification of the front-end device to request a central management server for a registration;
the device address receiving module is configured to: after the registration is successful, receive a device address assigned by the central management server to the front-end device; after the registration is successful, receive an address of the online management server sent by the central management server;
the getting online module is configured to: use the device address to request an online management server for being online; receive a request response fed back by the online management server;
the front-end device is configured to: carry the device identification of the front-end device to request the central management server for a registration; after the registration is successful, receive a device address assigned by the central management server to the front-end device; use the device address to request the online management server for being online; receive a request response fed back by the online management server;
the central management server is configured to: receive a registration request from the front-end device and complete a registration, wherein the registration request carries the device identification of the front-end device; assign a device address to the front-end device; send the device address to the front-end device, correlate the device address with the device identification of the front-end device and perform saving;
the online management server is configured to: receive a getting-online request from the front-end device, judge whether the front-end device is allowed to be online or not according to a device address in the getting-online request, and feed back a request response to the front-end device.
